(19) United States
(12) Patent Application Publication
(10) Pub. No.: US 2006/0271609 A1
(43) Pub. Date: Nov. 30, 2006

(54) Semiconductor memory device having matrix of memory banks for multi-bit input/output function

(75) Inventors: Hiroyuki Takahashi, Kawasaki (JP); Yoshiyuki Katoh, Kawasaki (JP); Masatoshi Sonoda, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/135,465

(22) Filed: May 24, 2005

(30) Foreign Application Priority Data
May 24, 2005 (JP) 2004-153356

(51) Int. Cl. G06F 15/00

(52) U.S. Cl. 708/200

(57) ABSTRACT

In a semiconductor apparatus for a multi-bit input/output function, a semiconductor memory chip includes 3^{m} rows, 3^{m} columns (m=1, 2, . . . ) of memory banks, each having a plurality of input/output terminals. The memory banks are adapted to carry out the same operation so that a predetermined number of bits are accessed from the input/output terminals of each of the memory banks.

### BACKGROUND OF THE INVENTION

1. Field of the Invention

The present invention relates to a semiconductor apparatus and more particularly, to a semiconductor memory device such as a dynamic random access memory (DRAM) device.

2. Description of the Related Art

DRAM devices have been developed to have high functioning and high integration.

One approach for achieving high functioning is a multi-bit input/output function. For example, a 4-bit input/output function associated with one parity bit, an 8-bit input/output function associated with one parity bit, a 16-bit input/output function associated with two parity bits, and a 32-bit input/output function associated with four parity bits have been developed. Further, a 2ⁿ-bit (n=6, 7, . . . ) input/output function will be developed. Such a multi-bit function would increase the number of input/output terminals or pads which are provided at peripheral edges of a semiconductor chip or at long-side edges thereof.

On the other hand, when the integration is highly enhanced, the circuitry of memory cells and transistors is also fine-structured, and simultaneously, the chip size is increased. When the chip size is increased, the connections are made longer which would increase the capacity thereof. As a result, since transmission speed of control signals and data signals is decreased, high speed access cannot be expected.

A prior art semiconductor memory device for an 8-bit input/output function associated with one parity bit is constructed by a memory cell array divided into a plurality of plates (sub blocks) and a plurality of input/output pads (see: JP-8-315578-A). In this case, one half of the input/output pads are provided on the upper outer periphery of the memory cell array, and the other half of the input/output pads are provided on the lower outer periphery of the memory cell array. This will be explained later in detail.

In the above-described prior art semiconductor memory device, however, in particular steps, although only one of the plates is required to be activated, two of them are activated so that the power consumption is increased.

Also, in the above-described prior art semiconductor memory device, since the distances between the input/output pads and the cells greatly fluctuate and the activated plates are non-uniformly distributed, a high speed access cannot be expected.

### SUMMARY OF THE INVENTION

It is an object of the present invention to provide a semiconductor memory device for a multi-bit input/output function capable of decreasing power consumption and increasing access speed.

According to the present invention, in a semiconductor apparatus for a multi-bit input/output function, a semiconductor memory chip includes 3^{m} rows, 3^{m} columns (m=1, 2, . . . ) of memory banks, each having a plurality of input/output terminals. The memory banks are adapted to carry out the same operation so that a predetermined number of bits are accessed from the input/output terminals of each of the memory banks.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating a prior art semiconductor memory device;

FIGS. 2A through 2D are diagrams for explaining a x36b4 operation of the semiconductor memory device of FIG. 1;

FIGS. 3A through 3D are diagrams for explaining a x18b4operation of the semiconductor memory device of FIG. 1;

FIGS. 4A through 4D are diagrams for explaining a x9b4 operation of the semiconductor memory device of FIG. 1;

FIGS. 5A and 5B are diagrams for explaining a problem in the semiconductor memory device of FIG. 1;

FIG. 6 is a block circuit diagram illustrating an embodiment of the semiconductor memory device according to the present invention;

FIG. 7 is a detailed block circuit diagram of one of the memory banks of FIG. 6;

FIG. 8 is a detailed circuit diagram of one of the plates of FIG. 7;

FIGS. 9 and 10A through 10D are diagrams for explaining a x36b4 operation of the semiconductor memory device of FIGS. 7 and 8;

FIGS. 11 and 12A through 12D are diagrams for explaining a x18b4 operation of the semiconductor memory device of FIGS. 7 and 8;

FIGS. 13 and 14A through 14D are diagrams for explaining a x9b4 operation of the semiconductor memory device of FIGS. 7 and 8;

FIG. 15A is a cross-sectional view of a semiconductor package into which the semiconductor memory device of FIG. 6 is mounted;

FIG. 15B is a plan view of the semiconductor memory device of FIG. 15A;

FIG. 15C is a plan view of the interposer substrate of FIG. 15A; and

FIGS. 16 and 17 are block circuit diagrams of modifications of the memory bank of FIG. 7.

### DESCRIPTION OF THE PREFERRED EMBODIMENT

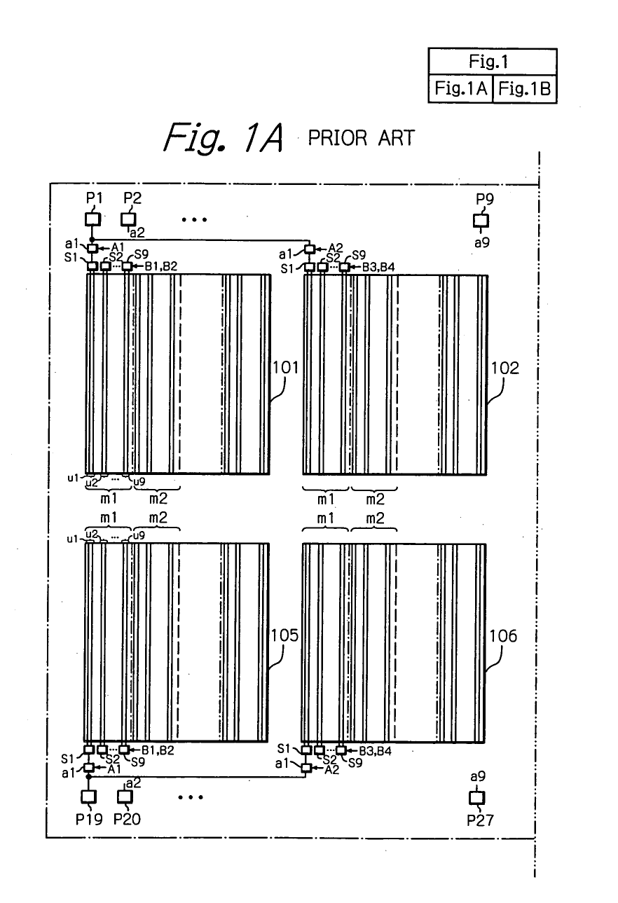

Before the description of the preferred embodiment, a prior art semiconductor memory device will be explained with reference to FIGS. 1, 2A, 2B, 2C, 2D, 3A, 3B, 3C, 3D, 4A, 4B, 4C, 4D, 5A and 5B (see: JP-8-315578-A).

In FIG. 1, which illustrates a prior art semiconductor memory device for an 8-bit input/output function associated with one parity bit, this semiconductor memory device is constructed by a memory cell array divided into 2×4 (=8) plates 101, 102, . . . , 108 and thirty-six input/output terminals or pads p1, p2, . . . , p18, p19, p20, . . . , p38. In this case, the input/output pads p1, p2, . . . , p18 are provided on the upper outer periphery of the memory cell array, and the input/output pads p19, p20, . . . , p36 are provided on the lower outer periphery of the memory cell array.

Each of the plates 101, 102, . . . , 108 are constructed by a plurality of memory mats m1, m2, . . . each formed by nine data units u1, u2, . . . , u9 each including two digit lines. The data units u1, u2, . . . , u9 are connected to selectors s1, s2, . . . , s9, respectively. Also, the selectors s1 are connected to a write amplifier/sense amplifier circuit a1, the selectors s2 are connected to a write amplifier/sense amplifier circuit a2, . . . , and the selectors s9 are connected to a write amplifier/sense amplifier circuit a9.

The input/output pads p1, p2, . . . , p9 are provided for the plates 101 and 102. That is, the write amplifier/sense amplifier circuits a1 of the plates 101 and 102 are connected to the input/output pad p1, the write amplifier/sense amplifier circuits a2 of the plates 101 and 102 are connected to the input/output pad p2, . . . , and the write amplifier/sense amplifier circuits a9 of the plates 101 and 102 are connected to the input/output pad p9.

The input/output pads p10, p11, . . . , p18 are provided for the plates 103 and 104. That is, the write amplifier/sense amplifier circuits al of the plates 103 and 104 are connected to the input/output pad p10, the write amplifier/sense amplifier circuits a2 of the plates 103 and 104 are connected to the input/output pad p11, . . . , and the write amplifier/sense amplifier circuits a9 of the plates 103 and 104 are connected to the input/output pad p18.

The input/output pads p19, p20, . . . , p27 are provided for the plates 105 and 106. That is, the write amplifier/sense amplifier circuits a1 of the plates 105 and 106 are connected to the input/output pad p19, the write amplifier/sense amplifier circuits a2 of the plates 105 and 106 are connected to the input/output pad p20, . . . , and the write amplifier/sense amplifier circuits a9 of the plates 105 and 106 are connected to the input/output pad p27.

The input/output pads p28, p29, . . . , p36 are provided for the plates 107 and 108. That is, the write amplifier/sense amplifier circuits a1 of the plates 107 and 108 are connected to the input/output pad p28, the write amplifier/sense amplifier circuits a2 of the plates 107 and 108 are connected to the input/output pad p29, . . . , and the write amplifier/sense amplifier circuits a9 of the plates 107 and 108 are connected to the input/output pad p36.

Also, a controller 109 is provided to generate activation signals A1, A2, A3 and A4 for activating write amplifiers or sense amplifiers and burst signals B1, B2, B3 and B4 as well as an X address signal and a Yⱼ address signal. Note that the activation signals A1, A2, A3 and A4 activate the corresponding write amplifiers in a write mode and activate the corresponding sense amplifiers in a read mode.

The selectors s1, s2, . . . , s9 connected to the plates 101 and 105 are controlled by the burst signals B1 and B2, and the write amplifier/sense amplifier circuits a1, a2, . . . , a9 connected to the plates 101 and 105 are activated by the activation signals A1.

The selectors s1, s2, . . . , s9 connected to the plates 102 and 106 are controlled by the burst signals B3 and B4, and the write amplifier/sense amplifier circuits a1, a2, . . . , a9 connected to the plates 102 and 106 are activated by the activation signals A2.

The selectors s1, s2, . . . , s9 connected to the plates 103 and 107 are controlled by the burst signals B1 and B2, and the write amplifier/sense amplifier circuits a1, a2,. . . , a9 connected to the plates 103 and 107 are activated by the activation signals A3.

The selectors s1, s2, . . . , s9 connected to the plates 104 and 108 are controlled by the burst signals B3 and B4, and the write amplifier/sense amplifier circuits a1, a2, . . . , a9 connected to the plates 104 and 108 are activated by the activation signals A4.

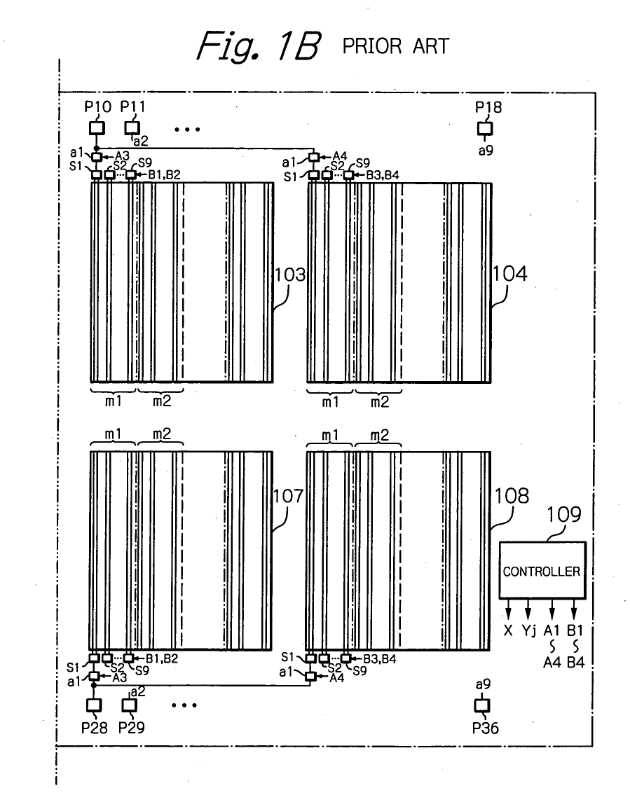

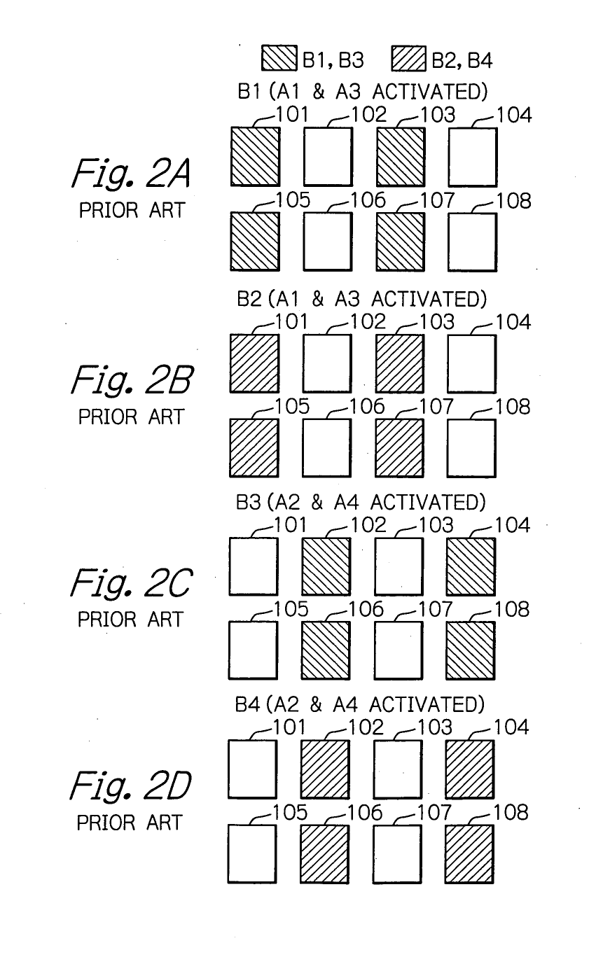

The x36b4 operation of the semiconductor memory device of FIG. 1 is explained next with reference to FIGS. 2A, 2B, 2C and 2D. Here, “x36” means that the data width is 36 bits and “b4” means that the burst length is 4.

First, as illustrated in FIG. 2A, the controller 109 generates activation signals A1 and A3 to activate the plates 101, 103, 105 and 106. Also, the controller 109 generates a burst signal B1, so that the selectors s1, s2, . . . , s9 of the plates 101, 103, 105 and 109 select the left side data of the selected data units.

Next, as illustrated in FIG. 2B, the controller 109 generates activation signals A1 and A3 to activate the plates 101, 103, 105 and 106. Also, the controller 109 generates a burst signal B2, so that the selectors s1, s2, . . . , s9 of the plates 101, 103, 105 and 109 select the right side data of the selected data units.

Next, as illustrated in FIG. 2C, the controller 109 generates activation signals A2 and A4 to activate the plates 102, 104, 106 and 108. Also, the controller 109 generates a burst signal B3, so that the selectors s1, s2, . . . , s9 of the plates 102, 104, 106 and 108 select the left side data of the selected data units.

Finally, as illustrated in FIG. 2D, the controller 109 generates activation signals A2 and A4 to activate the plates 102, 104, 106 and 108. Also, the controller 109 generates a burst signal B4, so that the selectors s1, s2, . . . , s9 of the plates 102, 104, 106 and 108 select the right side data of the selected data units.

Thus, in each step of the x36b4 operation, four of the plates 101, 102, . . . , 108 are activated.

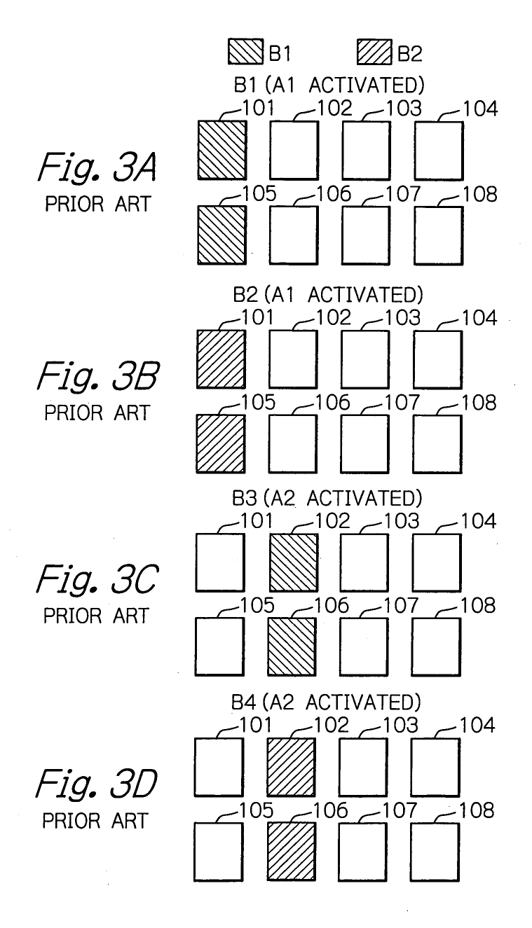

The x 18b4 operation of the semiconductor memory device of FIG. 1 is explained next with reference to FIGS. 3A, 3B, 3C and 3D. Here, “x18” means that the data width is 18 bits and “b4” means that the burst length is 4.

First, as illustrated in FIG. 3A, the controller 109 generates an activation signal A1 to activate the plates 101 and 105. Also, the controller 109 generates a burst signal B1, so that the selectors s1, s2, . . . , s9 of the plates 101 and 105 select the left side data of the selected data units.

Next, as illustrated in FIG. 3B, the controller 109 generates an activation signal A1 to activate the plates 101 and 105. Also, the controller 109 generates a burst signal B2, so that the selectors s1, s2, . . . , s9 of the plates 101 and 105 select the right side data of the selected data units.

Next, as illustrated in FIG. 3C, the controller 109 generates an activation signal A2 to activate the plates 102 and 106. Also, the controller 109 generates a burst signal B3, so that the selectors s1, s2, . . . , s9 of the plates 102 and 106 select the left side data of the selected data units.

Finally, as illustrated in FIG. 3D, the controller 109 generates an activation signals A2 to activate the plates 102 and 106. Also, the controller 109 generates a burst signal B4, so that the selectors s1, s2, . . . , s9 of the plates 102 and 106 select the right side data of the selected data units.

Thus, in each step of the x18b4 operation, two of the plates 101, 102, . . . , 108 are activated.

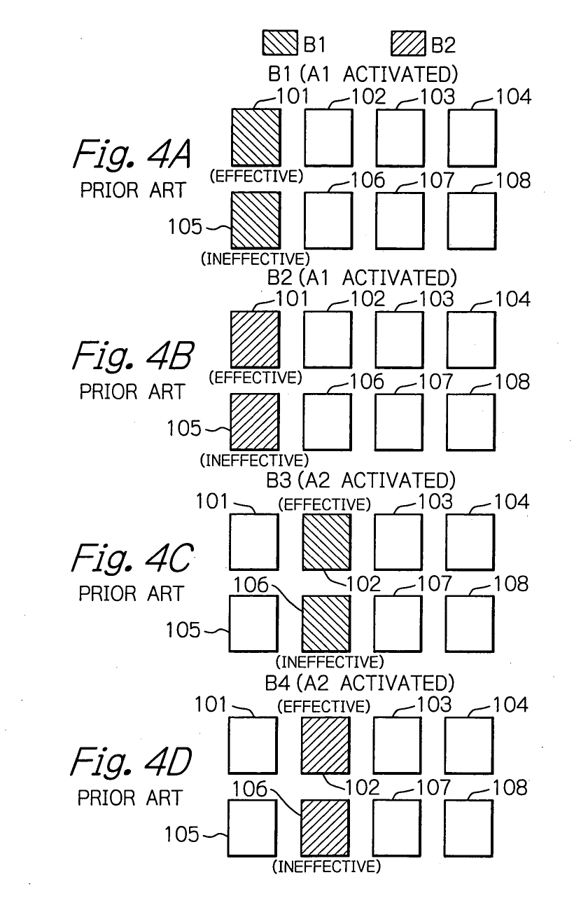

The x9b4 operation of the semiconductor memory device of FIG. 1 is explained next with reference to FIGS. 4A, 4B, 4C and 4D. Here, “x9” means that the data width is 9 bits and “b4” means that the burst length is 4. That is, FIGS. 4A, 4B, 4C and 4D are all the same as FIGS. 3A, 3B, 3C and 3D.

Thus, in each step of the x9b4 operation, two of the plates 101, 102, . . . , 108 are also activated. In this case, the input/output pads p1, p2, . . . , p9 are effective while the input/output pads p19, p20, . . . , p27 are ineffective. As a result, although only one of the plates 101, 102, 105 and 106 is required to be activated, two of them are activated so that the power consumption is increased.

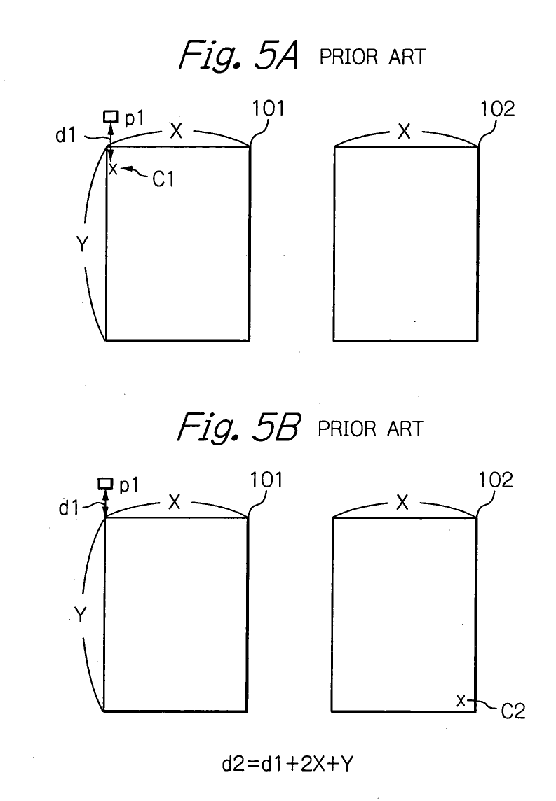

Also, in FIG. 1, the distances between the input/output pads p1, p2, . . . , p9, p10, p11, . . . , p18, p19, p20, . . . , p27, p28, p29, . . . , p36 and the cells greatly fluctuate. For example, the minimum distance is a distance d1 between the input/output pad p1 and a cell C1 as illustrated in FIG. 5A. On the other hand, the maximum distance is a distance between the input/output pad p1 and a cell C2 as illustrated in FIG. 5B which can be represented by
d1+2X+Y
where X is a width (arbitrary unit) of one plate;

Y is a length (arbitrary unit) of one plate. Further, as illustrated in FIGS. 2A, 2B, 2C, 2D, 3A, 3B, 3C, 3D, 4A, 4B, 4C and 4D, the activated plates are non-uniformly distributed. As a result, since the access speed depends upon the above-mentioned maximum distance of the activated plates, a high speed access cannot be expected.

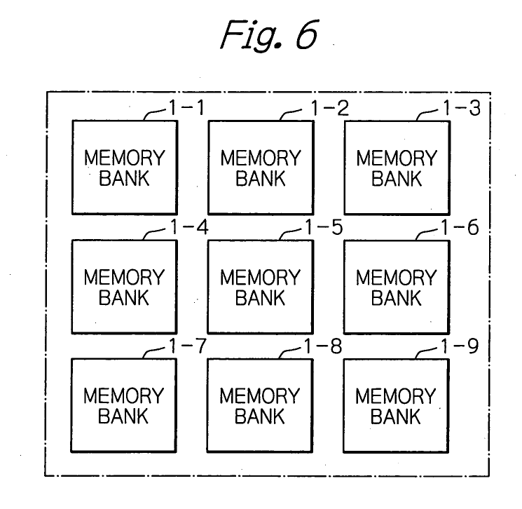

In FIG. 6, which illustrates an embodiment of the semiconductor memory device according to the present invention, this semiconductor memory device is divided into 3×3 (=9) memory banks 1-1 1-2, . . . , 1-9 having the same structure as each other. Also, provided between the memory bands 1-1, 1-2, . . . , 1-9 are an X address buffer, a Y address buffer, a test mode circuit, a reference voltage generating circuit and the like (not shown).

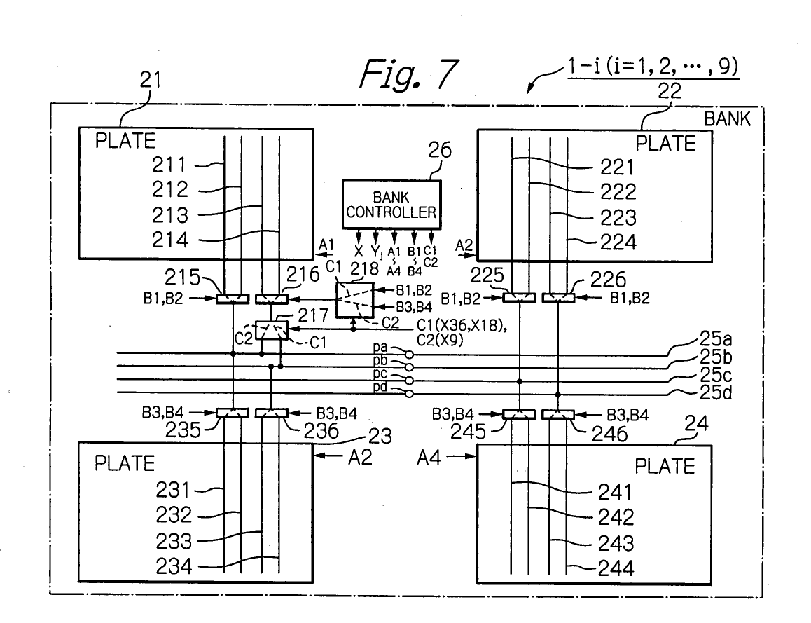

In FIG. 7, which is a detailed block circuit diagram of the memory bank 1-i(i=1, 2, . . . , 9) of FIG. 6, the memory bank 1-i is constructed by 2×2 (=4) plates (or sub blocks) 21, 22, 23 and 24 having the same structure as each other.

Also provided between the plates 21 and 22 and the plates 23 and 24 are data lines 25a, 25b, 25c and 25d which are also connected to input/output pads pa, pb, pc and pd, respectively. Note that the input/output pads pa, pb, pc and pd are located at approximately the center of each of the memory banks 1-1, 1-2, . . . , 1-9.

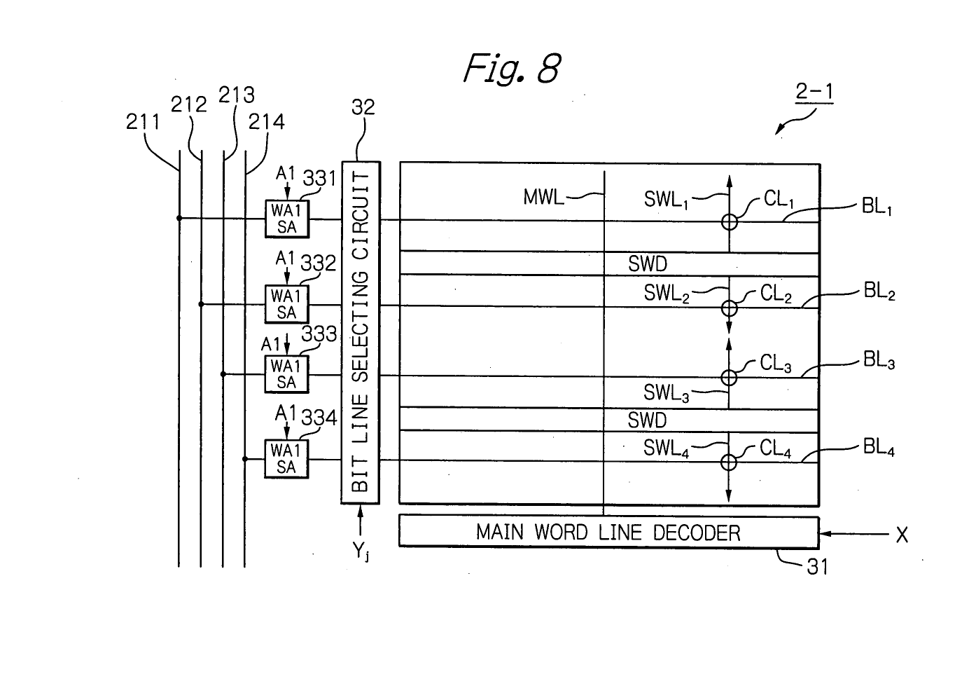

A bank controller 26 carries out X address control for main word lines and sub word line drivers, Y address control for bank select BS and Y select Yⱼ, write/read control for write amplifiers and sense amplifiers (see: FIG. 8), a burst control and input/output register control For example, the bank controller 26 receives data with a width of ×36, ×18 or ×9 and a burst length of b4 or b2 to generate a burst signal B1, B2, B3 or B4 and control signals C1 and C2 as well as activation signals A1, A2, A3 and A4 for activating the write amplifiers or sense amplifiers (see: FIG. 8) of the plates 21, 22, 23 and 24. Note that the control signal C1 is generated for the data width of ×36 or ×18, and the control signal C2 is generated for the data width of ×9.

The plate 21 has four sub data lines 211, 212, 213 and 214. The sub data lines 211 and 212 are selectively connected via a selector 215 to the data line 25a. The sub data lines 213 and 214 are selectively connected via selectors 216 and 217 to one of the data lines 25a and 25b. The selector 216 is controlled by a selector 218 which switches the burst signals B1 and B2 to the burst signals B3 and B4 or vice versa. In this case, the selector 215 is controlled by the burst signals B1 and B2, the selector 216 is controlled by the burst signals B1 and B2 for the data width of ×36 or ×18 and the burst signals B3 and B4 for the data width of ×9, and the selector 217 is controlled by the control signal C1 (×36 or ×18) and the control signal C2 (×9).

The plate 22 has four sub data lines 221, 222, 223 and 224. The sub data lines 221 and 222 are selectively connected via a selector 225 to the data line 25c, and the sub data lines 223 and 224 are selectively connected via a selector 226 to the data line 25d. In this case, the selectors 225 and 226 are controlled by the burst signals B1 and B2.

The plate 23 has four sub data lines 231, 232, 233 and 234. The sub data lines 231 and 232 are selectively connected via a selector 235 to the data line 25a, and the sub data lines 233 and 234 are selectively connected via a selector 236 to the data line 25b. In this case, the selectors 235 and 236 are controlled by the burst signals B3 and B4.

The plate 24 has four sub data lines 241, 242, 243 and 244. The sub data lines 241 and 242 are selectively connected via a selector 245 to the data line 25c, and the sub data lines 243 and 244 are selectively connected via a selector 246 to the data line 25d. In this case, the selectors 245 and 246 are controlled by the burst signals B3 and B4.

Note that the data lines 25a, 25b, 25c and 25d are used only within the corresponding the plate 1-i. Therefore, as the distances between the input/output pads pa, pb, pc and pd connected to the data lines 25a, 25b, 25c and 25d and each of the cells are small, a high speed access can be expected.

In FIG. 8, which is a detailed circuit diagram of one of the plates such as the plate 21 of FIG. 7, the plate 21 is constructed by a main word line decoder 31 for receiving the X address from the bank controller 26 to select one main word line MWL which activates two sub word line drivers (SWDs) each for selecting two sub word lines SWL₁ and SWL₂ (SWL₃ and SWL₄). Also, the plate 21 is constructed by a bit line selecting circuit 32 for receiving a Y address signal Yⱼ to select four bit lines BL₁, BL₂, BL₃ and BL₄. As a result, four memory cells CL₁, CL₂, CL₃ and CL₄ located at intersections between the sub word lines SWL₁, SWL₂, SWL₃ and SWL₄ and the bit lines BL₁, BL₂, BL₃ and BL₄ are connected to the sub data lines 211, 212, 213 and 214, respectively.

Also, provided between the sub data lines 211, 212, 213 and 214 and the bit line selecting circuit 32 are write amplifier/sense amplifier circuits 33-1, 33-2, 33-3 and 33-4, respectively, which are activated by the activation signal A1. Note that the write amplifiers of the circuits 33-1, 33-2, 33-3 and 33-4 are activated in a write mode and the sense amplifiers of the circuits 33-1, 33-2, 33-3 and 33-4 are activated in a read mode.

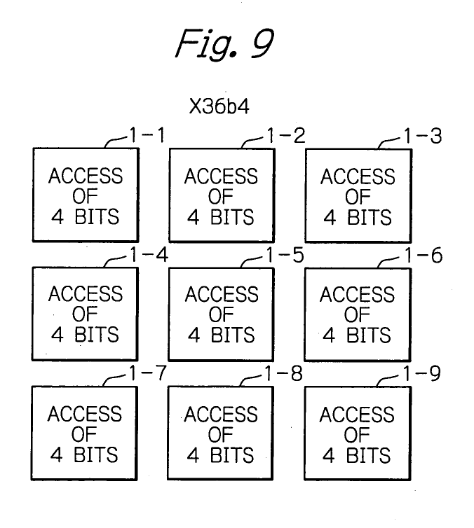

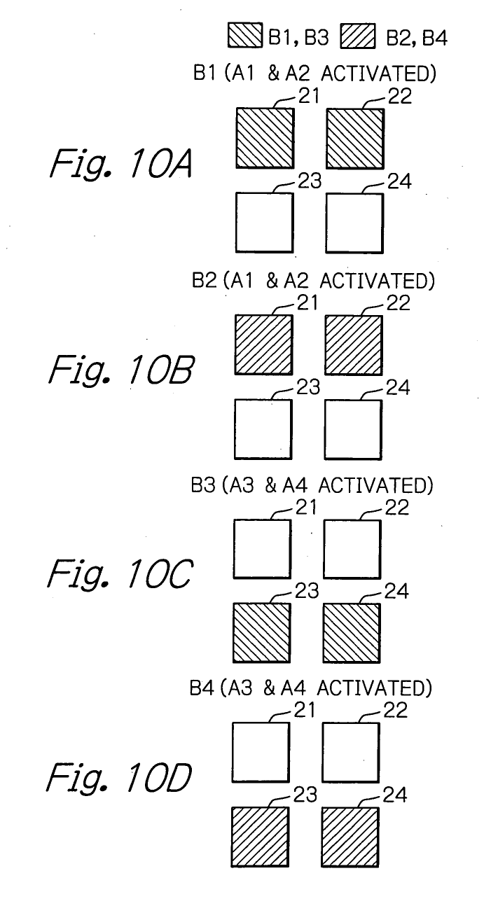

The x36b4 operation of the semiconductor memory device of FIGS. 7 and 8 is explained next with reference to FIGS. 9, 10A, 10B, 10C and 10D.

That is, at any step, as illustrated in FIG. 9, all the memory banks 1-1, 1-2, . . . , 1-9 are activated. In other words, the activated memory banks are uniformly distributed. As a result, 4 bits are accessed from each of the memory banks 1-1, 1-2, . . . , 1-9 which carry the same operation so that 36 bits (=9×4 bits) are accessed. One of the memory banks such as the memory bank 1-1 will be explained below.

First, as illustrated in FIG. 10A, the controller bank 26 generates activation signals A1 and A2 to activate the plates 21 and 22. Also, the bank controller 26 generates a burst signal B1. As a result, the selectors 215, 216 and 218 of the plate 21 select the left side sub data lines 211 and 213 while the selector 217 selects the data line 25b, and simultaneously, the selectors 225 and 226 of the plate 22 select the left side sub data lines 221 and 223.

Next, as illustrated in FIG. 10B, the controller bank 26 generates activation signals A1 and A2 to activate the plates 21 and 22. Also, the bank controller 26 generates a burst signal B2. As a result, the selectors 215, 216 and 218 of the plate 21 select the right side sub data lines 212 and 214 while the selector 217 selects the data line 25b, and simultaneously, the selectors 225 and 226 of the plate 22 select the right side sub data lines 222 and 224.

Next, as illustrated in FIG. 10C, the controller bank 26 generates activation signals A3 and A4 to activate the plates 23 and 24. Also, the bank controller 26 generates a burst signal B3. As a result, the selectors 235 and 236 of the plate 23 select the left side sub data lines 231 and 233, and simultaneously, the selectors 245 and 246 of the plate 24 select the left side sub data lines 241 and 243.

Finally, as illustrated in FIG. 10D, the controller bank 26 generates activation signals A3 and A4 to activate the plates 23 and 24. Also, the bank controller 26 generates a burst signal B4. As a result, the selectors 235, 236 of the plate 23 select the right side sub data lines 232 and 234, and simultaneously, the selectors 245 and 246 of the plate 24 select the left side sub data lines 242 and 244.

Thus, in the x36b2 operation, all the plates 21, 22, 23 and 24 are accessed.

Note that a x36b2 operation would be explained with reference to FIGS. 10A and 10B only.

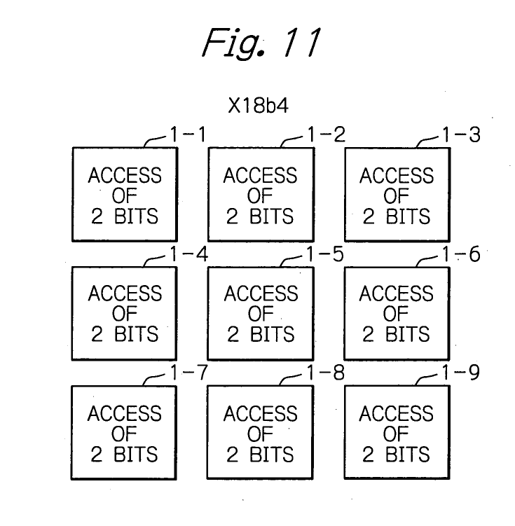

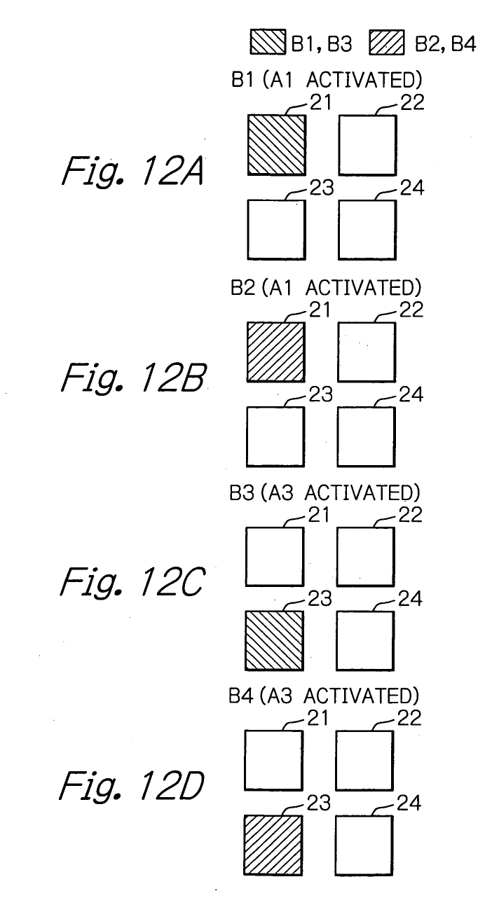

The x18b4 operation of the semiconductor memory device of FIGS. 7 and 8 is explained next with reference to FIGS. 11, 12A, 12B, 12C and 12D.

That is, at any step, as illustrated in FIG. 11, all the memory banks 1-1, 1-2, . . . , 1-9 are activated. In other words, the activated memory banks are uniformly distributed. As a result, 2 bits are accessed from each of the memory banks 1-1, 1-2, . . . , 1-9 which carry out the same operation so that 18 bits (=9×2 bits) are accessed. One of the memory banks such as the memory bank 1-1 will be explained below.

First, as illustrated in FIG. 12A, the controller bank 26 generates an activation signal A1 to activate the plate 21. Also, the bank controller 26 generates a burst signal B1. As a result, the selectors 215, 216 and 218 of the plate 21 select the left side sub data lines 211 and 213 while the selector 217 selects the data line 25b.

Next, as illustrated in FIG. 12B, the controller bank 26 generates an activation signal A1 to activate the plate 21. Also, the bank controller 26 generates a burst signal B2. As a result, the selectors 215, 216 and 218 of the plate 21 select the right side sub data lines 212 and 214 while the selector 217 selects the data line 25b.

Next, as illustrated in FIG. 12C, the controller bank 26 generates an activation signal A3 to activate the plate 23. Also, the bank controller 26 generates a burst signal B3. As a result, the selectors 235 and 236 of the plate 23 select the left side sub data lines 231 and 233.

Finally, as illustrated in FIG. 12D, the controller bank 26 generates an activation signal A3 to activate the plate 23. Also, the bank controller 26 generates a burst signal B4. As a result, the selectors 235, 236 of the plate 23 select the right side sub data lines 232 and 234.

Thus, in the x18b2 operation, only two plates, i.e., half of the plates 21, 22, 23 and 24 are accessed.

Note that a x18b2 operation would be explained with reference to FIGS. 12A and 12B only.

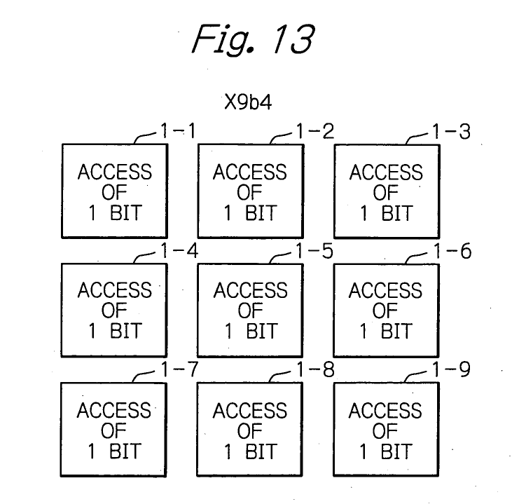

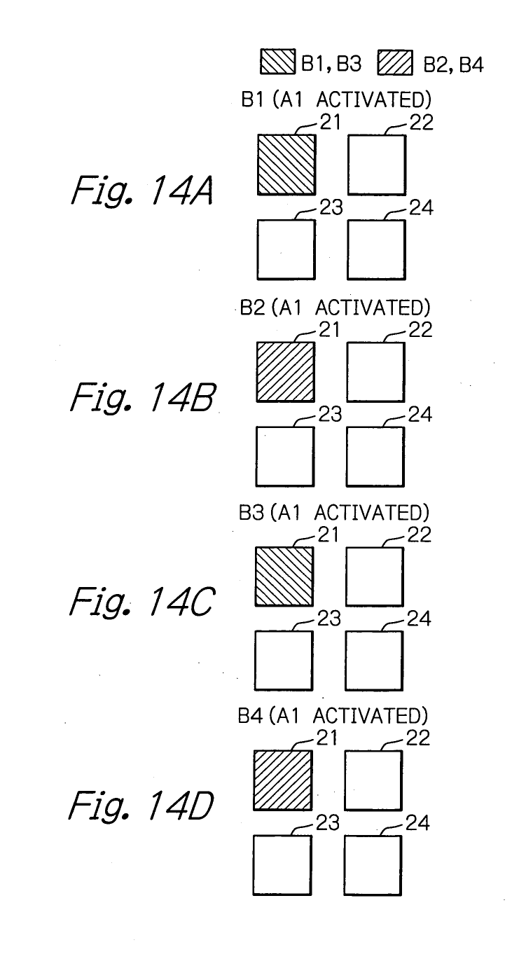

The x9b4 operation of the semiconductor memory device of FIGS. 7 and 8 is explained next with reference to FIGS. 13, 14A, 14B, 14C and 14D.

That is, at any step, as illustrated in FIG. 13, all the memory banks 1-1, 1-2, . . . , 1-9 are activated. In other words, the activated memory banks are uniformly distributed. As a result, 1 bit is accessed from each of the memory banks 1-1, 1-2,. . . , 1-9 which carry out the same operation so that 9 bits (=9×1 bits) are accessed. One of the memory banks such as the memory bank 1-1 will be explained below.

First, as illustrated in FIG. 14A, the controller bank 26 generates an activation signal A1 to activate the plate 21. Also, the bank controller 26 generates a burst signal B1. As a result, the selector 215 of the plate 21 selects the left side sub data line 211. In this case, the selector 216 is deactivated by the selector 218, so that none of the sub data lines 213 and 214 are selected.

Next, as illustrated in FIG. 14B, the controller bank 26 generates an activation signal A1 to activate the plate 21. Also, the bank controller 26 generates a burst signal B2. As a result, the selector 215 of the plate 21 selects the right side sub data lines 212. In this case, the selector 216 is deactivated by the selector 218, so that none of the sub data lines 213 and 214 are selected.

Next, as illustrated in FIG. 14C, the controller bank 26 generates an activation signal A1 to activate the plate 21. Also, the bank controller 26 generates a burst signal B3. As a result, the selector 216 of the plate 21 selects the left side sub data lines 211. In this case, the selector 216 is deactivated by the selector 218, so that none of the sub data lines 213 and 214 are selected.

Finally, as illustrated in FIG. 14D, the controller bank 26 generates an activation signal A1 to activate the plate 21. Also, the bank controller 26 generates a burst signal B4. As a result, the selector 216 of the plate 21 selects the right side sub data lines 214. In this case, the selector 216 is deactivated by the selector 218, so that none of the sub data lines 213 and 214 are selected.

Thus, in the x9b4 operation, only one plate, i.e., a quarter of the plates 21, 22, 23 and 24 are accessed.

Note that a x9b2 operation would be explained with reference to FIGS. 14A and 14B only.

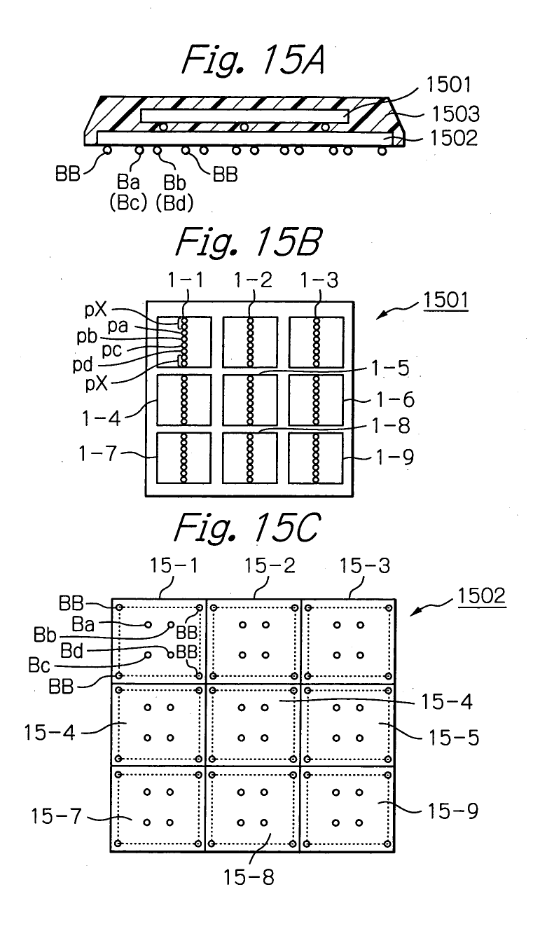

The semiconductor memory device of FIG. 6 is mounted into a ball grid array (BGA)-type package as illustrated in FIG. 15A.

In FIG. 15A, a semiconductor memory chip 1501 the same as the semiconductor memory device of FIG. 6 is adhered face down onto an interposer substrate 1502 made of polyimide or the like. Also, a sealing layer 1503 made of epoxy resin or the like is provided in a gap between the semiconductor memory chip 1501 and the interposer substrate 1502 and covers the semiconductor memory chip 1501.

As illustrated in FIG. 15B, each memory bank 1-1, 1-2, . . . , 1-9 of the semiconductor memory chip 1501 has control pads pX in addition to the input/output pads pa, pb, pc and pd which are arranged in a line at the center thereof.

Also, as illustrated in FIG. 15C, the interposer substrate 1503 is divided into ball areas 15-1, 15-2, . . . , 15-9 corresponding to the memory banks 1-1, 1-2, . . . , 1-9, respectively, of FIG. 15B. In each of the ball areas 15-1, 15-2, . . . , 15-9, solder balls Ba, Bb, Bc and Bd corresponding to the input/output pads pa, pb, pc and pd, respectively, of FIG. 15B and solder balls BB corresponding to the control pads pX of FIG. 15B are provided.

Thus, the distances between the input/output pads pa, pb, pc and pd and their corresponding solder balls Ba, Bb, Bc and Bd can be minimized, which would further realize a higher speed access.

In the above-described embodiment, although 3 rows, 3 columns memory banks 1-1, 1-2, . . . , 1-9 are provided, 3^{m} rows, 3^{m} columns (m=2, 3, . . . ) memory banks such as 9 rows, 9 columns memory banks and 27 rows, 27 columns memory banks can be provided. Also, although each bank is provided with 2 rows, 2 columns plates, each bank can be provided with 2n rows, 2n columns (n=2, 3, . . . ) plates such as 4 rows, 4 columns plates and 8 rows, 8 columns plates.

Also, the sizes of the memory banks 1-1, 1-2, . . . , 1-9 can be different from each other, and the sizes of the plates 21, 22, 23 and 24 can be different from each other.

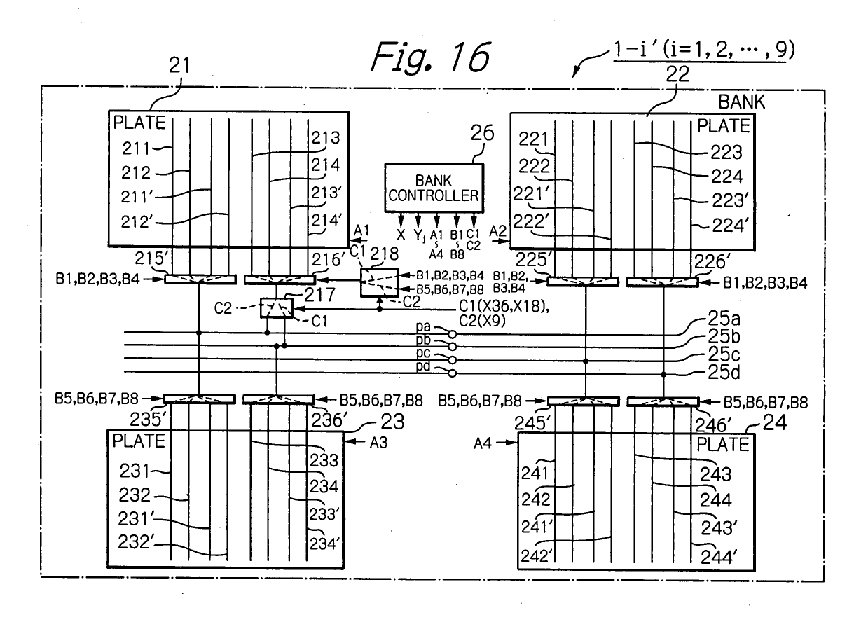

Further, the burst length can be increased. For example, if the burst length is 8, the plate 1-i of FIG. 7 is modified to a plate 1-i′ as illustrated in FIG. 16. That is, the bank controller 26 generates additional burst signals B5, B6, B7 and B8. Also, sub data lines 211′, 212′, 213′ and 214′, sub data lines 221′, 222′, 223′ and 224′, sub data lines 231′, 232′, 233′ and 234′, sub data lines 241′, 242′, 243′ and 244′ are added to the plates 21, 22, 23 and 24, respectively, of FIG. 7. Also, the selectors 215, 216, 225 and 226 are replaced by selectors 215′, 216′, 225′ and 226′, respectively, which are controlled by the burst signals B1, B2, B3 and B4, and the selectors 235, 236, 245, 246 are replaced by the selectors 235′, 236′, 245′ and 246′, respectively, which are controlled by the burst signals B5, B6, B7 and B8. Further, the selector 218 switches the burst signals B1, B2, B3 and B4 and the burst signals B5, B6, B7 and B8.

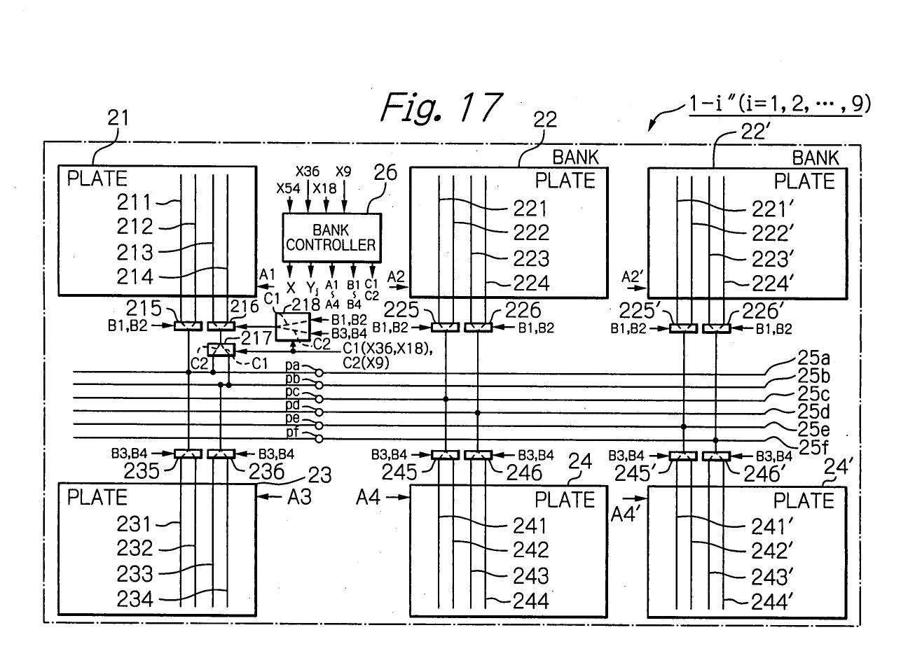

Additionally, the data width can be increased. For example, if the data width is 54, the plate 1-i of FIG. 7 is modified to a plate 1-i″ as illustrated in FIG. 17. That is, the bank controller 26 additionally receives a X54 signal to generate burst signals A2′ and A4′. Also, data lines 25e and 25f connected to input/output pads pe and pf are added. Further, a plate 22′ including sub data lines 221′, 222′, 223′ and 224′ is added and connected via selectors 225′ and 226′ controlled by the burst signals B1 and B2 to the data lines 25e and 25f, and a plate 24′ including sub data lines 241′, 242′, 243′ and 244′ is added and connected via selectors 245′ and 246′ controlled by the burst signals B3 and B4 to the data lines 25e and 25f. Note that the plates 22′ and 24′ are activated by the burst signals A2′ and A4′, respectively.

As explained hereinabove, according to the present invention, the power consumption can be decreased and the access speed can be increased.

1. A semiconductor apparatus for a multi-bit input/output function comprising a semiconductor memory chip including 3^{m} rows, 3^{m} columns (m=1, 2, . . . ) of memory banks, each having a plurality of input/output terminals,
said memory banks adapted to carry out the same operation so that a predetermined number of bits are accessed from said input/output terminals of each of said memory banks.

2. The semiconductor apparatus as set forth in claim 1, wherein said input/output terminals are located at approximately the center of each of said memory banks.

3. The semiconductor apparatus as set forth in claim 1, further comprising an interposer substrate divided into a plurality of areas each corresponding to one of said memory banks,
a plurality of external terminals provided in each of said areas being connected to said input/output terminals of one of said memory banks.

4. The semiconductor apparatus as set forth in claim 1, wherein each of said semiconductor memory banks comprises:
a plurality of plates each adapted to be activated independently; and
a plurality of data lines each connected to one of said input/output terminals, and selectively connected to said plates.

5. The semiconductor apparatus as set forth in claim 4, wherein the number of said plates in 2n×2n (n=1, 2, . . . ).

6. The semiconductor apparatus as set forth in claim 4, wherein each of said plates comprises a plurality of sub data line pairs selectively connected to said data lines.

7. The semiconductor apparatus as set forth in claim 4, wherein, in each of said memory banks, a first state where all said plates are activated, a second state where half of said plates are activated, and a third state where a quarter of said plates are activated can be established.

8. A semiconductor memory device for a multi-bit input/output function comprising:
3 rows, 3 columns of memory banks;
a plurality of groups of input/output terminals each group provided in one of said memory banks; and
a plurality of groups of data lines each group provided in one of said memory banks, each of said data lines being connected to one of said input/output terminals, each of said groups of data lines being located and used within only one of said memory banks.

9. The semiconductor memory device as set forth in claim 8, wherein each of said memory banks comprises a plurality of plates adapted to be activated independently.

10. The semiconductor memory device as set forth in claim 8, wherein each of said memory banks further comprises:
a selector circuit adapted to connect said plates to said data lines.

11. The semiconductor memory device as set forth in claim 8, wherein said input/output terminals are connected to external terminals of an interposer substrate.

12. A semiconductor memory device for a multi-bit input/output function comprising:
a plurality of memory banks;
a plurality of input/output terminals; and
a plurality of data lines adapted to connect said input/output terminals to said memory banks,
each of said data lines being located and used within only one of said memory banks.

13. A semiconductor memory device for a multi-bit input/output function comprising 3 rows, 3 columns of memory banks,
data including at least one parity bit being dispersed to said memory banks.
